(19) United States
(12) Patent Application Publication
(10) Pub. No.: US 2004/0258575 A1
(43) Pub. Date: Dec. 23, 2004

(54) Vaccum manifold for both multi-well plate and individual columns

(75) Inventor: Brian A. Perry, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Bio-Rad Laboratories, Inc., Hercules, CA (US)

(21) Appl. No.: 10/885,938

(22) Filed: Jul. 6, 2004

Related U.S. Application Data
(63) Continuation of application No. 09/872,817, filed on May 31, 2001, now abandoned.

(51) Int. Cl. B01L 11/00

(52) U.S. Cl. 422/102

(57) ABSTRACT

An adapter plate transforms a vacuum manifold designed for standard multi-well plates that are commonly used in biochemical laboratories into one that can be used for columns such as chromatographic columns, filtration columns, and the like. The plate contains an array of male-female-type complementary connectors, each connector fitted with a removable plug that seals the connector off when not in use. The plate thus allows the manifold to be used for as few as one column or any number up to the total number of connectors in the plate.

### BACKGROUND AND SUMMARY OF THE INVENTION

In research facilities, diagnostic clinics, forensic laboratories, and other environments where biological systems are studied, laboratory procedures of many types are performed, and many of these procedures involve a step in which vacuum-induced flow is used to draw a liquid through a reaction well, a filtration medium, or a chromatographic separation medium of various kinds. Standardized pieces of equipment such as microtitration plates, filtration plates and the like are commonly used for processing multiple samples simultaneously. One of the most common designs for such plates is a 96-well array (8×12) in a plastic plate in which the bottom of each well is a membrane or filter that allows liquid reagents to pass and the appropriate chromatographic processes to occur. Vacuum-induced flow is produced in these plates by a vacuum manifold, which is a receptacle into which the multi-well plate is placed such that when a vacuum is applied to the receptacle interior, fluid in each well of the plate is drawn out through the base of the well.

The present invention expands the usefulness of such vacuum manifolds by making them suitable for producing vacuum-induced flow through individual columns, such as packed sample preparation (purification) columns, in addition to multi-well plates. The columns of interest are those that terminate in the male portions of a LUER-LOK®-type fitting (LUER-LOK is a registered trademark of Becton, Dickinson) or of similar male-female-type connectors that form air-tight flow passages and arc manually engageable and disengageable in a quick-connect manner. The terms “LUER-LOK-type” and “LUER-type” are used herein to denote any mated connector pair that is manually engageable and disengageable and functions similar to the LUER-LOK connectors that are commonly known and used. Such connectors are widely used on syringe tips and the ends of chromatographic columns for ready connection to other columns, tubing or vessels. Engagement and disengagement by a friction fit between the complementary male and female components and may or may not be further supplemented with a complementary screw interaction, depending on whether or not the components are threaded.

The invention resides in an adapter plate that is placed on the vacuum manifold opening that would otherwise be occupied by the multi-well plate. The adapter plate has an array of fittings forming through-passages, each of which has the female portion of a LUER-type component or connection embedded in the passage. The connection may be a friction fit or an interlocking connection, or a combination of both. Closing each female portion is a removable plug that may be similar in contour to the male portion that is a part of the syringe or column. The plug however lacks a through-passage of its own and thereby serves as a stopper of the through-passage in the adapter plate. When the user seeks to produce vacuum-induced flow in a given number of columns, for example, an equal number of plugs is removed from the adapter plate and replaced by the columns so that all through-passages in the plate are either occupied by columns or closed off by the plugs. The vacuum manifold is therefore adaptable for use with any number of columns ranging from one to a number equal to the total number of through-passages in the plate.

These and other features of the invention will become clearer from the description that follows.

### BRIEF DESCRIPTION OF THE DRAWINGS

FIG. 1 is an exploded perspective view of a vacuum manifold and adapter plate in accordance with the present invention.

FIG. 2 is a side view of a portion of the adapter plate included in FIG. 1.

### DETAILED DESCRIPTION OF THE INVENTION AND PREFERRED EMBODIMENTS

While this invention is susceptible to a variety of configurations, arrangements and embodiments, the following discussion will focus on a specific example, the structural and functional aspects of which will serve to provide an understanding of the invention as a whole.

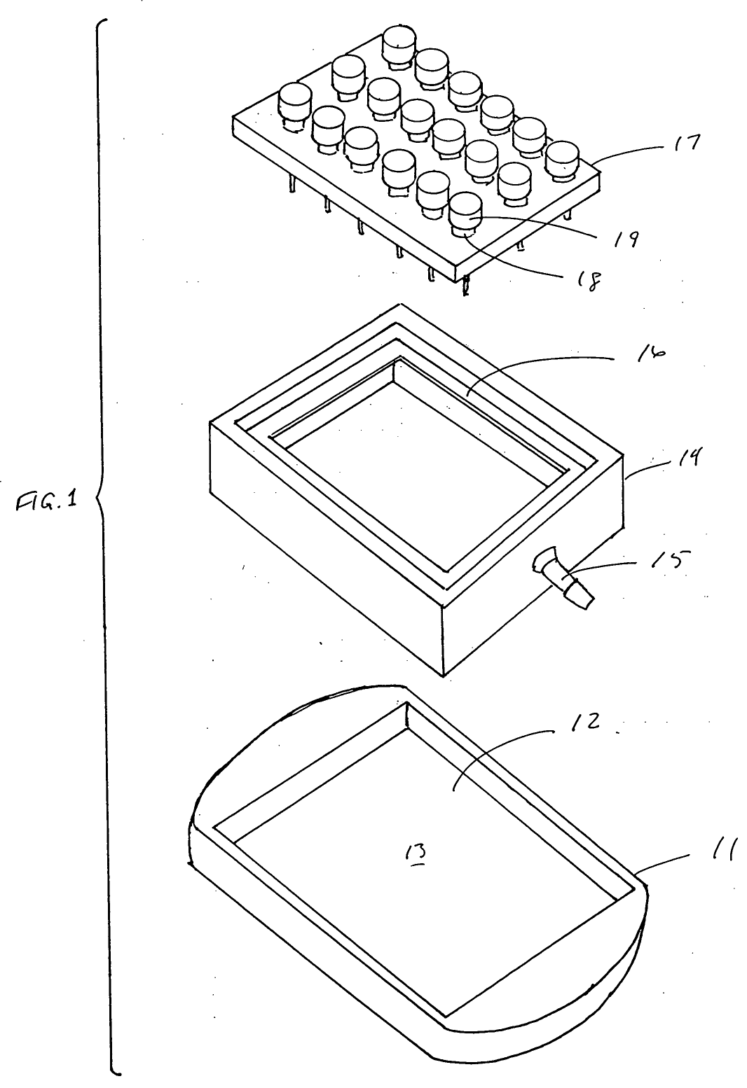

FIG. 1 depicts three components that together constitute a representative vacuum manifold and adapter plate in accordance with the invention. The lowermost of these components is a base 11 which is a generally rectangular plate with a rectangular depression 12 at its center to form the floor 13 of the vacuum chamber and to receive the hollow rectangular shell 14 which forms the side walls of the chamber. The shell 14 is open at the top and bottom, and its bottom edge fits snugly into the depression 12 in the base plate and establishes a gasketed, air-tight interaction when vacuum is applied. One side of the shell contains a port with a vacuum tubing connection 15. Extending around the inside wall of the shell is a gasketed shoulder or ledge 16 which supports either a multi-well plate (such as a 96-well sample plate, filtration plate or microtitration plate) or an adapter plate 17.

The adapter plate 17 is shown at the top of FIG. 1, and has the same dimensions as the multi-well plate so that it can rest snugly on the shoulder 16 inside the shell 14 and yet is easily removed by hand. Embedded in the adapter plate are a series of female portions 18 of male-female LUER-type connectors to mate with the male portions that are designed into the lower ends of syringes and chromatographic cartridges and columns. Each of the female connector portions passes through the adapter plate to form a through-passage communicating with the vacuum chamber formed by the base plate 11 as the floor of the chamber, the shell 14 as the side walls, and the adapter plate 17 as the roof. Each embedded female connector portion is enclosed by a plug 19 when not in use.

The number and arrangement of these connectors embedded in the adapter plate are not critical to the invention and can vary widely. The plate shown in the drawing contains 18 such connectors, thereby accommodating any number of columns ranging from one to 18. Other arrays with higher or lower numbers of connectors can also be used.

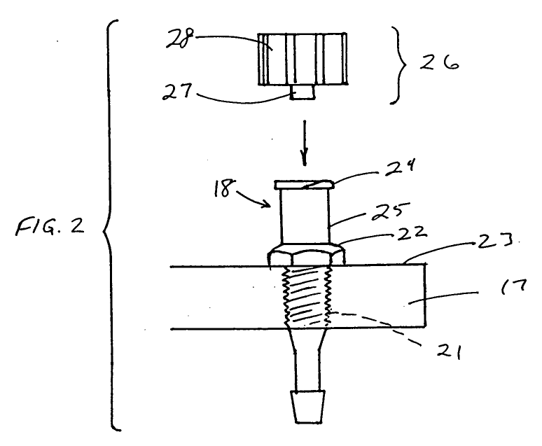

FIG. 2 is an enlarged view of a section of the adapter plate 17 showing a single connector portion 18. The connector passes through a threaded hole 21 in the plate and is secured in place by a faceted protrusion or nut-like extension 22 which abuts the upper surface 23 of the plate. The female LUER-type connector 24 is supported by a hollow shaft 25 extending upward. Poised above the connector is a plug 26 with a protruding post 27 that fits inside the connector 24 and extends into hollow shaft. The post 27 is solid and thereby blocks flow through the connector and holds a vacuum in the underlying vacuum chamber when the connector is not in use. The interior of the plug (not visible in the Figure) has the same connecting features as the male LUER-type connector that is included at the tip of a column or syringe. The outer surface 28 of the plug may be ridged or knurled to facilitate gripping and twisting by the user's thumb and forefinger.

This invention also extends to adapters for manifolds that are designed to accommodate two or more multi-well plates in a side-by-side arrangement. Some or all of the multi-well plates can be replaced by adapters.

The materials of construction are not critical to the invention and can vary widely, provided that they are inert to the reagents and other substances that are placed in contact with the manifold, and that they are sufficiently sturdy and solid to hold a vacuum. Transparent materials, particularly plastic, are convenient and allow monitoring of the procedures.

The foregoing is offered primarily for purposes of illustration. Further alternatives as well as modifications and variations of the configurations, systems, materials, and procedural steps described above, which will be apparent to those skilled in the art upon reading this specification, are included within the scope of this invention.

1. A vacuum manifold for interchangeably accommodating a multi-well plate and one or a plurality of individual chromatography columns terminating in male portions of one or a plurality of male-female-type air-tight manually operable [engageable] connectors [whose male and female portions are interlocking], said vacuum manifold comprising:
a plate perforated with a plurality of through-passages, each through-passage having embedded therein a female portion of said male-female-type air-tight manually operable [engageable]connector;
a plurality of individually removable plugs, each said plug shaped to mate with one of said female portions to form a substantially airtight closure of said through-passage; and
a receptacle with an open top and a port for drawing a partial vacuum in said receptacle, said receptacle containing an internal shoulder encircling said open top and sized to receive said plate [means for supporting said plate across said open top].

2. An adapter for a vacuum manifold, which manifold is designed to produce vacuum-induced flow through all wells of a multi-well laboratory plate, said adapter rendering said vacuum manifold usable for producing vacuum-induced flow through one or a plurality of individual chromatography columns terminating in male portions of one or a plurality of male-female-type air-tight manually operable [engageable] connectors [whose male and female portions are interlocking], said adapter comprising:
a plate whose lateral dimensions are substantially the same as those of said multi-well laboratory plate, said plate having a plurality of through-passages, each through-passage having embedded therein a female portion of said male-female-type air-tight manually operable [engageable] connector; and
a plurality of individually removable plugs, each said plug shaped to mate with one of said female portions embedded in said plate to form a substantially airtight closure of said through-passage.
